(19) United States
(12) Patent Application Publication
(10) Pub. No.: US 2010/0034256 A1
(43) Pub. Date: Feb. 11, 2010

(54) VIDEO FRAME/ENCODER STRUCTURE TO INCREASE ROBUSTNESS OF VIDEO DELIVERY

(75) Inventor: James D. Bennett, Hroznetin (CZ)

Correspondence Address: GARLICK HARRISON & MARKISON, P.O. BOX 160727, AUSTIN, TX, 78716-0727, US

(73) Assignee: Broadcom Corporation, Irvine, CA (US)

(21) Appl. No.: 12/277,992

(22) Filed: Nov. 25, 2008

Related U.S. Application Data
(60) Provisional application No. 61/086,577, filed on Aug. 6, 2008.

(51) Int. Cl. H04N 7/12

(52) U.S. Cl. 375/240.01

(57) ABSTRACT

An Internet program infrastructure communicates a plurality of Internet protocol video program packets from a source end to recipient end device in an optimized and adaptive manner. Optimization functionalities are distributed through the Internet program infrastructure within a source end, a recipient end, and/or nodes of a servicing communication pathway. Selectively, one or more of decoding, adaptive and optimized compression, transcoding, video quality adaptation, missing frame generation, time shifting and tone adaptation, re-encoding and multiplexing functionalities may be employed at the source end, recipient end device and/or nodes of the communication pathway. All of these optimizing functionalities are based upon feedback from the communication pathway nodes or recipient end device that may include traffic density and traffic handling capabilities and recipient end device configuration specific information such as buffering and processing capabilities, screen aspect ration and size, and audio reproduction capabilities.

### BACKGROUND

1. Technical Field

The present invention relates generally to multimedia communication; and, more particularly to video streaming.

2. Related Art

The broadcast of digitized video/audio information (multimedia content) is well known. Limited access communication networks such as cable television systems, satellite television systems, and direct broadcast television systems support delivery of digitized multimedia content via controlled transport medium. In the case of a cable modem system, a dedicated network that includes cable modem plant is carefully controlled by the cable system provider to ensure that the multimedia content is robustly delivered to subscribers∞ receivers. Likewise, with satellite television systems, dedicated wireless spectrum robustly carries the multi-media content to subscribers' receivers. Further, in direct broadcast television systems such as High Definition (HD) broadcast systems, dedicated wireless spectrum robustly delivers the multi-media content from a transmitting tower to receiving devices. Robust delivery, resulting in timely receipt of the multimedia content by a receiving device is critical for the quality of delivered video and audio.

Some of these limited access communication networks now support on-demand programming in which multimedia content is directed to one, or a relatively few number of receiving devices. The number of on-demand programs that can be serviced by each of these types of systems depends upon, among other things, the availability of data throughput between a multimedia source device and the one or more receiving devices. Generally, this on-demand programming is initiated by one or more subscribers and serviced only upon initiation.

Publicly accessible communication networks, e.g., Local Area Networks (LANs), Wireless Local Area Networks (WLANs), Wide Area Networks (WANs), Wireless Wide Area Networks (WWANs), and cellular telephone networks, have evolved to the point where they now are capable of providing data rates sufficient to service streamed multimedia content. The format of the streamed multimedia content is similar/same as that that is serviced by the limited access networks, e.g., cable networks, satellite networks. However, each of these communication networks is shared by many users that compete for available data throughput. Resultantly, streamed multimedia content is typically not given preferential treatment by these networks.

Generally, streamed multimedia content is formed/created by a first electronic device, e.g., web server, personal computer, user equipment, etc., transmitted across one or more communication networks, and received and processed by a second electronic device, e.g., personal computer, laptop computer, cellular telephone, WLAN device, or WWAN device. In creating the multimedia content, the first electronic device obtains/retrieves multimedia content from a video camera or from a storage device, for example, and encodes the multimedia content to create encoded audio and video frames according to a standard format, e.g., Quicktime, (motion picture expert group) MPEG-2, MPEG-4, or H.264, for example. The encoded audio and video frames are placed into data packets that are sequentially transmitted from the first electronic device onto a servicing communication network, the data packets addressed to one or more second electronic device(s). The sequentially transmitted sequence of encoded audio/video frames may be referred to as a video stream or an audio/video stream. One or more communication networks carry the data packets to the second electronic device. The second electronic device receives the data packets, reorders the data packets if required, and extracts the encoded audio and video frames from the data packets. A decoder of the second electronic device decodes the encoded audio and/or video frames to produce audio and video data. The second electronic device then stores the video/audio data and/or presents the video/audio data to a user via a user interface.

Each video frame is carried by one or more data packets. When data packets are lost or damaged in transit, the decoding component of the second electronic device produces output with missing information, e.g., blank portions in a video image for a period of time that is noticeable to a user. These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a schematic block diagram illustrating an infrastructure that communicates a plurality of Internet protocol video program packets from a source end to a recipient end device according to one or more embodiments of the present invention;

FIG. 2 is a schematic block diagram illustrating another embodiment of an infrastructure wherein source end channel optimization modules are incorporated into a digital program source according to one or more embodiments of the present invention;

FIG. 3 is a schematic block diagram illustrating components of communication pathways of FIGS. 1 and 2 of the present invention wherein communication pathway nodes monitor and provide feedback on channel conditions and include channel optimization modules that assist in producing an optimal delivery system according to one or more embodiments of the present invention;

FIG. 4 is a schematic block diagram illustrating components of a channel optimization module of a source end device that assists in producing an optimal delivery system in accordance with one or more embodiments of the present invention;

FIG. 5 is a schematic block diagram illustrating functionality of distributed channel optimization modules in accordance with one or more embodiments of the present invention;

FIG. 6 is a flow diagram illustrating functionality of a channel optimization module according to one or more embodiments of the present invention;

FIG. 7 is a flow diagram illustrating functionality of a channel optimization module at of a communication pathway node according to one or more embodiments of the present invention;

FIG. 8a is a flow diagram illustrating functionality of channel optimization modules at a recipient end device that may include missing frame generation and time shifting and tone adaptation according to one or more embodiments of the present invention;

FIG. 8b is a flow diagram illustrating functionality of channel optimization modules at the source end or communication pathway nodes that may include one or more of feeding back channel condition information, video quality adaptation, missing frame generation, and time shifting and tone adaptation, transcoding, video quality adaptation, and time shifting and tone adaptation according to one or more embodiments of the present invention;

FIG. 9a is a flow diagram illustrating functionality of channel optimization modules at the source end or communication pathway nodes for adaptive and optimized compression according to one or more embodiments of the present invention; and

FIG. 9b is a flow diagram illustrating functionality of re-encoding and multiplexing at the source end or communication pathway nodes according to one or more embodiments of the present invention.

### DETAILED DESCRIPTION OF THE DRAWINGS

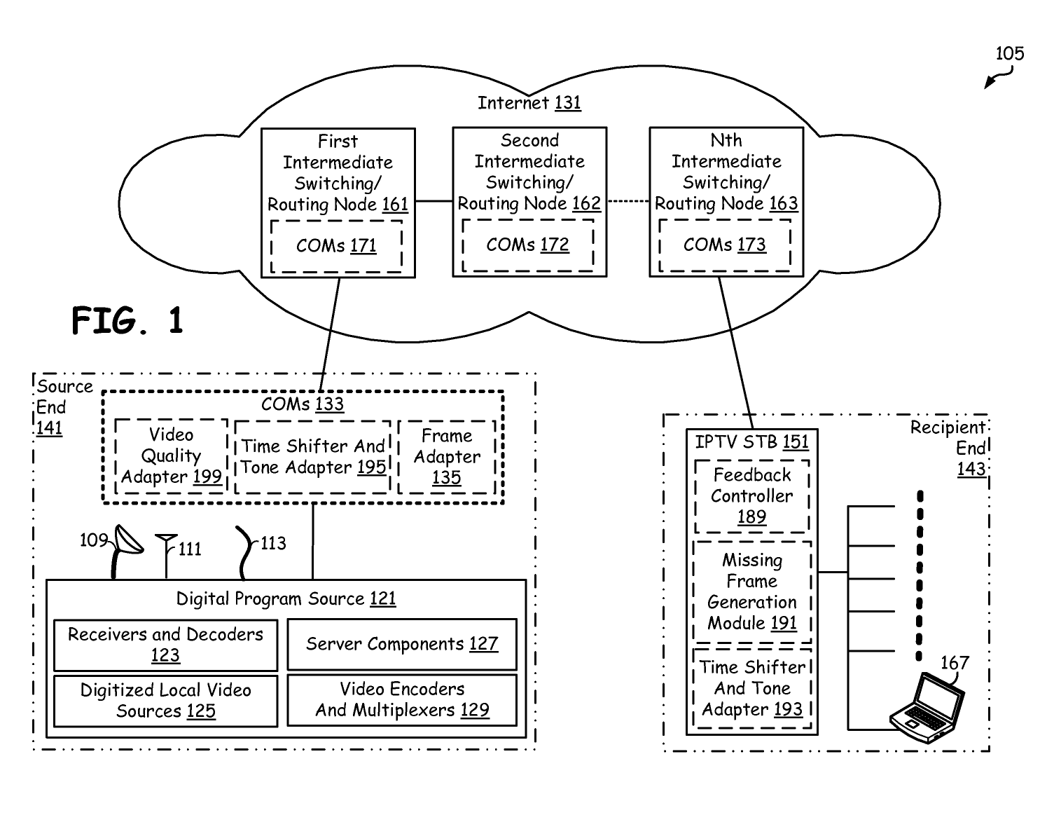

FIG. 1 is a schematic block diagram illustrating an infrastructure that communicates a plurality of Internet protocol video program packets from a source end to a recipient end device according to one or more embodiments of the present invention. The infrastructure 105 of FIG. 1 includes a source end 141 that communicates a plurality of Internet protocol video program packets to a recipient device 167; wherein one or more of distributed channel optimization modules 133, 171, 172 and 173, such as video frame adapters, video quality adapters, time shifting and tone adaptation modules, and missing frame generation modules, assist in producing an optimal delivery system. In specific, the channel optimizing modules 133, 171, 172 and 173 are incorporated at the source end 141 and at plurality of nodes 161, 162 and 163 of a communication pathway in the Internet 131 as well as at the recipient end 143 in a distributed manner. Channel Optimization Modules (COMs) 133, 171, 172 and 173 may contain one or more of feedback controller, video frame adapter, video quality adapter, time shifting and tone adaptation module, and missing frame generation module that assist in producing an optimal delivery system.

The feedback controllers employed at the communication pathway nodes 161, 162 and 163, and recipient end 143 (for example at Internet Protocol Television Set Top Box “IPTV STB” 151, i.e., feedback controller 189) provide feedback on channel conditions such as traffic handling capability of a node 161, 162 or 163 and traffic density at the moment of arrival of Internet protocol video program packets at the node 161, 162 or 163, and delay times, as well as in case of recipient end 143, providing recipient end device configuration information, to preceding nodes as well as to the source end 141. These preceding nodes containing channel optimization modules 171, 172 and 173 as well as source end channel optimization modules 133 adapt many variables while generating Internet protocol video program packets in an optimal manner so as to save channel bandwidth, for example, while providing optimal quality at the recipient end device 167, all of which are done dynamically (that is, as and when channel conditions and recipient device configurations are changed, the channel optimization modules 133, 171, 172 and 173 automatically generate optimal Internet protocol video program packets to suit the corresponding channel conditions or recipient end 167 device configurations).

The channel optimization modules 133, 171, 172 and 173 typically contain feedback controller, video frame adapter, video quality adapter, time shifting and tone adaptation module, and missing frame generation module in a distributed manner, each having a specific function in generating an optimal Internet protocol video program packet delivery system. The functionality of feedback controller as mentioned above is to feedback channel conditions and recipient end device 167 specific configuration information such as screen size, aspect ratio, mono, stereo, surround sound audio as well as buffering and processing capabilities. The video frame adapters, such as 135, adapts video frames to optimize the recipient end device resources, video quality adapters, such as 199, adapt video frame rate, pixel and color resolutions to optimize channel and recipient end device resources, time shifting and tone adaptation modules, such as 195 and 193, synchronize and tone adapt audio signals to compensate for the video quality adaptation or lost video frames, and missing frame generation modules, such as 191, restore missing frames that are lost during transmission.

In other words, the Internet program infrastructure 105, containing the source end 141, communication pathway including 161, 162 and 163 and recipient end 143, in a distributed manner, performs one or more functionalities of adapting video frames, adapting video quality, synchronizing and tone adaptation of audio signals, and generating any missing frames based upon channel conditions and the recipient device configurations, dynamically, to produce an optimal delivery system. These functionalities are performed partly or fully by one or more of the distributed components of the video frame adapters, video quality adapters, time shifting and tone adaptation modules and missing frame generation modules, to produces the optimal delivery system.

At the source end 141, a digital program source 121 sources Internet protocol video program packets and contains a satellite dish 109, an antenna 111 (to receive locally broadcast programs, for example) and cable or fiber optic connections 113, to communicate with external program sources. To source Internet protocol video program packets, the digital program source 121 contains receivers and decoders 123, digitized local video sources 125, server components 127 and video encoders and multiplexers 129.

The channel optimization modules 133 at the source end 141 are incorporated at the front end of the digital program source 121. It contains a plurality of modules including the frame adapter 135, video quality adapter 199 and time shifter and tone adapter 195. The channel optimization modules 133 initially de-multiplex and decode the incoming Internet protocol video program packets to generate digital audio and video signals.

Then, the video quality adapter 199 varies frame rate, pixel and color resolutions in response to a frame set backdrop, determined based upon minimum number of frames per second and minimum pixel and color resolutions required, for a set of frames, for not having a discernable difference in picture quality. In addition, the video quality adapter 199 also utilizes information from the feedback controller 189, and that in 171, 172, and 173, providing channel condition information, to adapt video quality, by varying the frame rate, pixel, and color resolutions. For example, a small screen, such as that of a handheld video player, may require very low pixel and color resolutions, which along with a frame rate may still be reduced based upon the frame rate backdrop. The frame set backdrop, for a frame set that contains fast action scenes, would be very high. For example, a racing car scene may involve quick changes in pixel contents between frames and as a result even with reduced frame rate, a user may not be able to discern a significant change in quality. The pixel and color resolution may also be reduced during the periods when frame set backdrop is high, without causing any discernable deterioration in quality of moving pictures in a video. On the contrary, dialogue and still frame scenes may result in a high frame rate and pixel and color resolution to increase picture quality when the frame set backdrop is low.

Similarly, frame adapter 135 compresses the digital video signal in an optimal and adaptive manner. Feedback control data determines an optimum number of referencing and re-referencing frames within a frame set (that is, adaptive and optimal compression) obtained from the feedback controller 189 (and that in 171, 172 and 173, providing channel condition information). Then, time shifter and tone adapter 195 applies synchronization and compensative sound effects on the digital audio signals to compensate for the adaptive reductions in frame rate (performed by video quality adapter 199). The time shifting involves the elimination of digital audio signals that correspond to the adaptive reductions in frame rate and resynchronization. The tone adaptation functionality involves gradual upward frequency shift during a period of frame reduction followed by gradual downward frequency shift after the last frame reduction begins to increase. Then, the channel optimization modules 133 re-encode digital audio, video and data signals to generate optimized Internet protocol video program packets and send it along the communication pathway to the recipient end 143.

At the recipient end 143, the IPTV STB 151 itself may contain a few of the channel optimization modules such as feedback controller 189, missing frame generation module 191, and time shifter and tone adapter 193. Once the incoming Internet protocol video program packets are de-multiplexed and decoded, the digital audio and video signals are extracted. The digital video signals contain video frame information, where one or more frames may be missing (lost) during transmission. The missing frame generation module 191 identifies these missing sequential video frames among the buffered video frames. Then, the missing frame generation module 191 identifies preceding and succeeding sequential video frames, of the missing sequential video frames and computes pixel and color magnitudes, in their respective pixel and color positions, of each of the preceding and succeeding sequential video frames.

Then, the missing frame generation module 191 identifies similarities in the magnitudes that fall within a threshold, in their respective pixel and color positions, between the preceding and succeeding sequential video frames, and generates similar pixels and colors of the missing sequential video frames. These similar pixels and colors in their respective positions are common for all of the missing sequential video frames. Then, the missing frame generation module 191 computes average values (in case of one missing video frame) or incremental magnitudes (in case of more than one missing sequential video frames), for each of the missing sequential video frames, in their respective pixel and color positions, when the magnitudes fall beyond the threshold, from the preceding and succeeding sequential video frames and thus generates difference pixels and colors of the missing sequential video frames. Once, similar and difference pixels and colors are generated for each of the missing sequential video frames, the missing frame generation module 191 generates each of the missing sequential video frames by combining the similar pixels and colors of the missing sequential video frames and difference pixels and colors of the missing sequential video frames, in their respective missing video frames, and pixel and color positions. Then, the time shifter and tone adapter 193 applies modifications and compensative sound effects on the digital audio signals to compensate for the missing video frames that can not be restored, similar to that of time shifter and tone adapter 195 at the source end 141. Then, the time shifted and tone adapted audio signal is delivered to an audio port, while video signals from the missing frame generation module are delivered to a video port and data signals are delivered to a data port.

In addition, the communication pathway nodes such as 161, 162 and 163 in a distributed manner may also perform one or more functionalities of adapting video frames, adapting video quality, synchronizing and tone adaptation of audio signals, and generating any missing frames (each of these functionalities are described above) based upon channel conditions and the recipient device configurations to produce an optimal delivery system, dynamically. These functionalities are performed partly of fully by channel optimizing modules 171, 172, or 173, containing modules such as the video frame adapters, video quality adapters, time shifting and tone adaptation modules and missing frame generation modules.

For example, a notebook computer 167 may be connected to the IPTV STB 151, to receive digital video programs from the digital program source 121. The channel optimization modules 133 determine the video frame and video quality adaptation parameters along with compression technology and corresponding parameters by receiving the notebook computer 167 video and audio configurations (a small or large window on the notebook computer 167 screen, for example), along with channel condition information received from the communication pathway nodes such as 161, 162 and 163. Then, the frame adapter 135 compresses the digital video signal in an optimal and adaptive manner (by varying number of referencing and re-referencing frames) and video quality adapter 199 dynamically varies the frame rate, color and pixel resolutions on the basis of the frame set backdrop, audio and video configurations of the notebook computer 167 and channel condition information. During the process of video quality adaptation, the time shifter and tone adapter 195 performs time shifting and tone adaptation on the digital audio program signals. In addition, some of the above mentioned channel optimization module 171, 172 and 173 functionalities may also be performed by the nodes 161, 162 and 163, either alone or in conjunction with the source end 141.

The video program signals received by the notebook computer 167 with missing video frames cause unwanted effects in the reproduction at screen and speakers. The missing frame generation module 191 of the IPTV STB 151 begins to buffer video frames sequentially, and in the meanwhile keeps searching for any missing video frames in the buffer. If the missing sequential video frames are identified, then the missing frame generation module 191 identifies preceding and succeeding sequential video frames from the buffer and computes pixel and color magnitudes, in their respective pixel and color positions. Then, the missing frame generation module 191 identifies similarities in the magnitudes that fall within a threshold (determined on the basis of an average user's inability to distinguish any difference between two video frames with minor differences), in their respective pixel and color positions, between the preceding and succeeding sequential video frames, and generates similar pixels and colors of the missing sequential video frames.

Then, the missing frame generation module 191 computes incremental magnitudes for each of the missing sequential video frames, in their respective pixel and color positions, when the magnitudes fall beyond the threshold, from the preceding and succeeding sequential video frames and thus generates difference pixels and colors of the missing sequential video frames. Then, the missing frame generation module 191 generates each of the missing sequential video frames by combining the similar pixels and colors of the missing sequential video frames and difference pixels and colors of the few missing sequential video frames, in their respective video frames, and pixel and color positions.

Then, the time shifter and tone adapter 193 applies the above mentioned modifications and sound effects on the digital audio signals. As a result, the digital video signals received by the notebook computer 167 produce no discernable deterioration in video or audio reproductions, even when many frames are dropped, missing, or lost. The IPTV STB 151 thus uses minimum buffering and processing powers, while the optimized Internet protocol video program packets utilize bare minimum bandwidth.

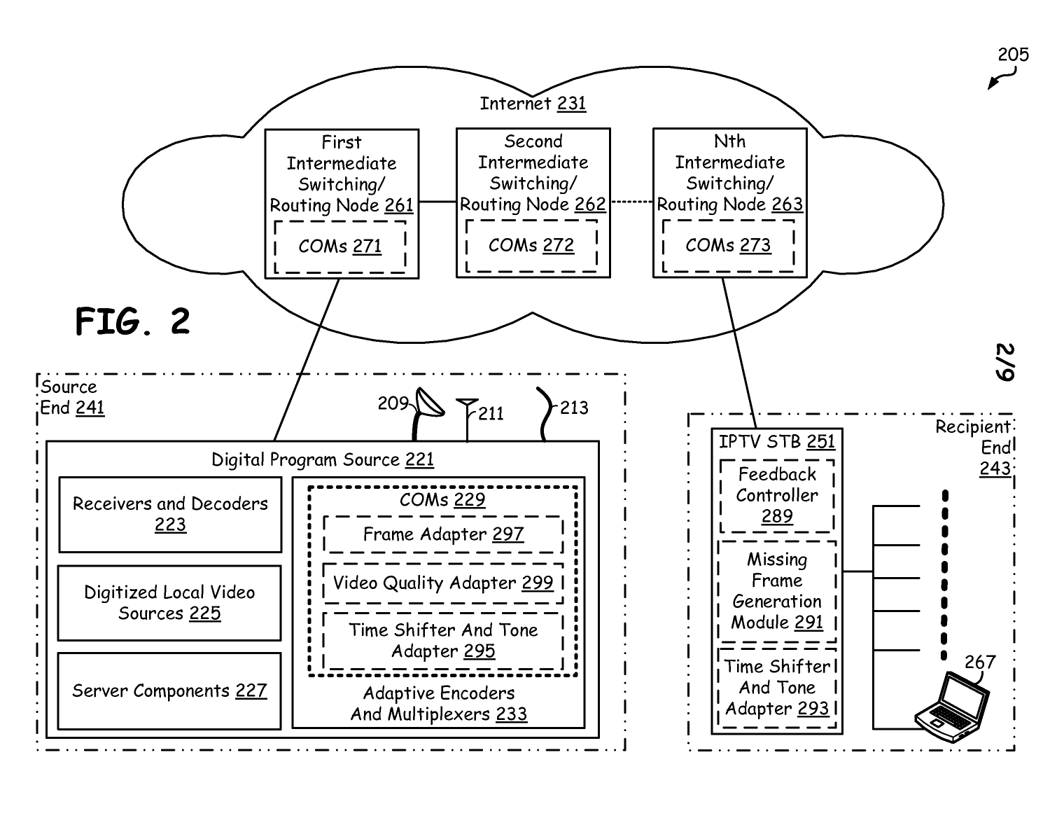

FIG. 2 is a schematic block diagram illustrating another embodiment of an infrastructure wherein source end channel optimization modules are incorporated into a digital program source according to one or more embodiments of the present invention. With the infrastructure 205 of FIG. 2, the functionality of the channel optimization modules 229 are incorporated into digital program source 221, directly. The channel optimization modules 229 containing frame adapter 297, video quality adapter 299, and time shifter and tone adapter 295 are incorporated into modified adaptive encoder and multiplexer 233 in accordance with the present invention. The infrastructure 205 illustrates another embodiment of the present invention, wherein the modified adaptive encoder and multiplexer 233 containing the channel optimization modules 229 are built into the digital program source 221.

The illustration 205 depicts a recipient end 243 that includes an IPTV STB 251 communicatively coupled to a recipient end device 267, in turn communicatively coupled to the digital program source 221 via Internet 231. The Internet 231 contains a plurality of nodes 261, 262 and 263, each containing its own channel optimization modules 271, 272, and 273. The illustration 205 also depicts various components of the digital program source 221 that include receivers and decoders 223, digitized local video sources 225, server components 227, communication tools to receive external programs from their source such as a satellite dish 209, an antenna 211 and cable or fiber optic connections 213, and the (modified) adaptive encoder and multiplexer 233 containing the channel optimization modules 229.

The adaptive encoder and multiplexer 233 receives digital audio, video and data signals from digitized local video source 225 or receivers and decoders 223 (that is, from an external program source). Optionally, the adaptive encoder and multiplexer 229 transcodes raw audio, video, and data signals to optimally suit the requirements of the recipient end device 267. The channel optimization modules 229 contain the frame adapter 297, video quality adapter 299, and time shifter and tone adapter 295. The channel optimization modules 229 receive digital audio and video signals from adaptive encoder and multiplexer 233, and perform their functionality before encoding and multiplexing.

The video quality adapter 299 varies frame rate, pixel and color resolutions in response to a frame set backdrop, determined based upon minimum number of frames per second and minimum pixel and color resolutions required, for a set of frames, for not having a discernable difference in picture quality; based upon channel condition information received from channel optimization modules 271, 272 and 273 and feedback controller 289, and recipient device configurations. Similarly, frame adapter 297 compresses the digital video signal in an optimal and adaptive manner, by optimally generating number of referencing and re-referencing frames within a frame set based upon channel condition information obtained from the feedback controller 289 (and that in 271, 272 and 273, providing channel condition information) and recipient device configuration data. Then, time shifter and tone adapter 295 applies synchronization and compensative sound effects on the digital audio signals to compensate for the adaptive reductions in frame rate (performed by video quality adapter 299).

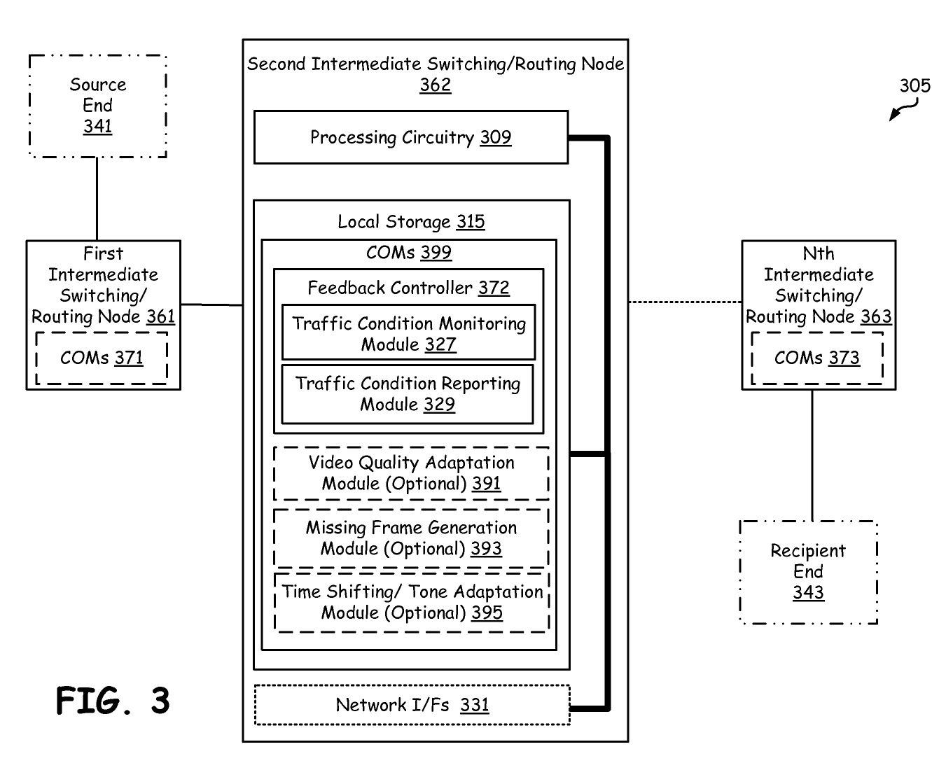

FIG. 3 is a schematic block diagram illustrating components of communication pathways of FIGS. 1 and 2 of the present invention wherein communication pathway nodes monitor and provide feedback on channel conditions and include channel optimization modules that assist in producing an optimal delivery system according to one or more embodiments of the present invention. With the components 305 of FIG. 3, communication pathway nodes 361, 362 and 363 monitor and provide feedback on channel conditions, and also optionally perform additional functionalities that assist in producing an optimal delivery system. A source end 341 and recipient end 343 communicatively couple via the intermediate nodes such as 361, 362, and 363, each of the nodes containing channel optimization modules 371, 399, and 373. The illustration 305 also depicts one of the intermediate nodes 362 containing processing circuitry 309, network interfaces 331 and local storage 315 containing the channel optimization modules 399.

The channel optimization modules 399 contain feedback controller 372, which in turn contain traffic condition monitoring module 327 and traffic condition reporting module 329. These two modules 327 and 329 monitor channel condition such as traffic handling capability of the node 362 and traffic density, and report these information to preceding node 361 as well as source end 341. Optionally, channel monitoring modules 399 also contain video quality adaptation module 391, missing frame generation module 393, and time shifting and tone adaptation module 395.

The video quality adaptation module 399 varies frame rate, pixel and color resolutions in response to a frame set backdrop, determined based upon minimum number of frames per second and minimum pixel and color resolutions required, for a set of frames, for not having a discernable difference in picture quality; based upon channel condition information received from channel optimization modules 373 and recipient device configurations. The missing frame generation module 393 identifies similarities in the magnitudes that fall within a threshold, in their respective pixel and color positions, between the preceding and succeeding sequential video frames, and generates similar pixels and colors of any missing sequential video frames. Then, the missing frame generation module 393 computes average values (in case of one missing video frame) or incremental magnitudes (in case of more than one missing sequential video frames), for each of the missing sequential video frames, in their respective pixel and color positions, when the magnitudes fall beyond the threshold, from the preceding and succeeding sequential video frames and thus generates difference pixels and colors of the missing sequential video frames. Once, similar and difference pixels and colors are generated for each of the missing sequential video frames, the missing frame generation module 393 generates each of the missing sequential video frames by combining the similar pixels and colors of the missing sequential video frames and difference pixels and colors of the missing sequential video frames, in their respective missing video frames, and pixel and color positions. Then, the time shifter and tone adapter 395 applies modifications and compensative sound effects on the digital audio signals to compensate for the missing video frames that can not be restored.

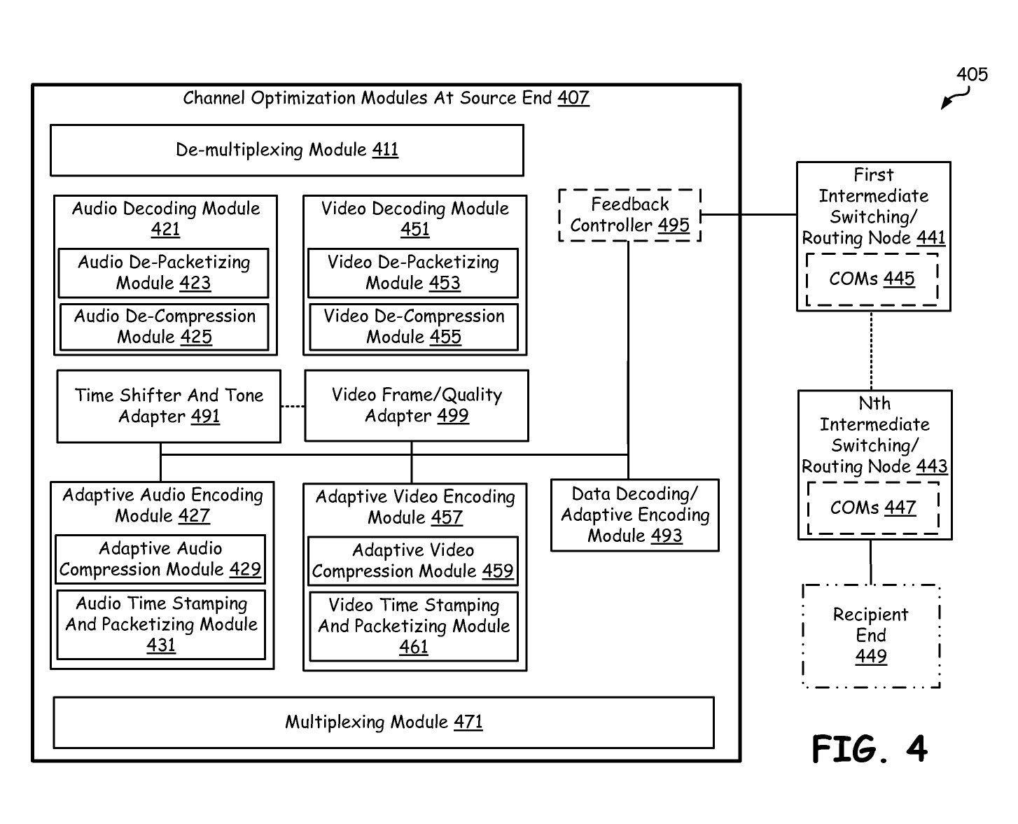

FIG. 4 is a schematic block diagram illustrating components of a channel optimization module of a source end device that assists in producing an optimal delivery system in accordance with one or more embodiments of the present invention. Components of the channel optimization modules 407 at the source end assist in producing an optimal delivery system. The channel optimization modules 407 include video quality and frame adapter 499 and time shifter and tone adapter 491 that are incorporated at front end of the digital program source (121 of FIG. 1, for example) and in addition, contain a plurality of modules to de-multiplex, decode and re-encode audio, video and data signals embedded in the IP program packets received from the digital program source.

The plurality of modules, at the receiving end of the channel optimization modules 407 includes a de-multiplexing module 411. The de-multiplexing module 411 separates audio, video and data IP program packets from the incoming IP program signals and delivers them to corresponding audio decoding module 421, video decoding module 451 and data decoding/adaptive encoding module 493.

The audio decoding module 421 contains audio de-packetizing module 423 and audio decompression module 425. The audio de-packetizing module 423 removes IP protocol information from the audio IP packets, extracts and delivers compressed audio signals (for example, using MP3 compression format), to the audio decompression module 425. The audio decompression module 425 decompresses the incoming compressed audio signals and extracts the digital audio signal in a standard format. The digital audio signal is delivered to a time shifter and tone adapter 491, which in turn applies modifications and compensative sound effects on the digital audio signals to compensate for the adaptive reductions in frame rate (performed by video quality adapter 499).

Then, the time shifted and tone adapted audio signal is delivered to an adaptive audio encoding module 427, which in turn contains an adaptive audio compression module 429 and audio time stamping and packetizing module 431. The adaptive audio compression module 429 compresses the time shifted and tone adapted audio signal in an optimal and adaptive manner. The feedback control data for determining optimum and adaptive compression is obtained from a feedback control unit 495, which in turn receives channel condition information and recipient device configuration information from channel optimization modules 445 and 447 of intermediate nodes 441, 443, respectively, and recipient end 449. Then, the audio time stamping and packetizing module 431 inserts IP protocol information time stamps the incoming compressed audio stream to convert the compressed audio signals to IP audio program packets and delivers them to a multiplexing module 471.

Similarly, the video decoding module 451 contains video de-packetizing module 453 and video decompression module 455, which in turn remove IP protocol information from the audio IP packets and extract compressed video signals (for example, using MPEG4 compression format), and then decompress them to extract the digital video signal in a standard format, respectively. The video quality and frame adapter's 499 functionality involves varying frame rate, pixel and color resolutions in response to a frame set backdrop and compressing the digital video signal in an optimal and adaptive manner, by optimally generating number of referencing and re-referencing frames within a frame set, based upon channel condition information obtained from channel optimization modules 445 and 447 and recipient device configurations.

Then, an adaptive video compression module 459 and a video time stamping and packetizing module 461 contained in adaptive video encoding module 457 compress the video quality adapted signals in an optimal and adaptive manner and then insert IP protocol information and time stamp on the incoming compressed video stream to convert the compressed video signals to IP video program packets and deliver them to the multiplexing module 471. The feedback control data determines an optimum number of referencing and re-referencing frames within a frame set (that is, adaptive and optimal compression) is obtained from a feedback control unit 495, which in turn receives channel condition information and recipient device configuration information from channel optimization modules 445 and 447 of intermediate nodes 441, 443 and recipient end 449. In addition, the data decoding/adaptive encoding module 493 decodes and then adaptively encodes the data stream in an analogous fashion to that of audio and video decoding and adaptive encoding process, based upon feedback control data from the feedback control unit 495.

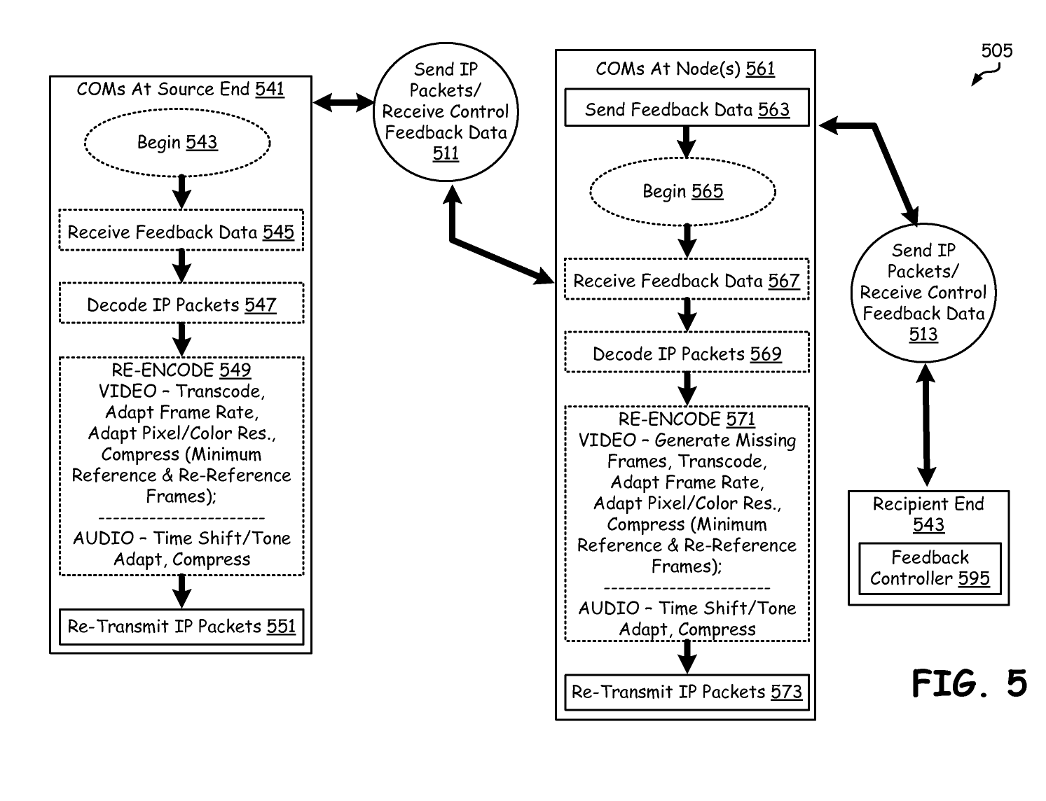

FIG. 5 is a schematic block diagram illustrating functionality 505 of distributed channel optimization modules in accordance with one or more embodiments of the present invention. The processes of an optimal delivery system begins at the source end with channel optimizing modules 541 performing many tasks including receiving feedback data 545, decoding Internet Protocol (IP) packets 545, and re-encoding 549 them in an adaptive and optimal manner. The optimal and adaptive encoding processes include transcoding, adapting frame rates, adapting video quality, compressing in an optimal manner and also, audio time shifting and tone adaptations. Finally these optimized IP program packets are retransmitted 551.

These processes at the source end begin at 543. The channel optimization modules 541 at regular intervals receive channel condition information and recipient device configuration information 545 from intermediate nodes 561 and recipient end 543 feedback controllers 595 via other nodes 511, 513. The channel optimization modules at the source end 541 then decode 547 the incoming Internet protocol video program packets to generate digital audio and video signals.

Then, the channel optimization modules 541 begin re-encoding processes 549 based upon the received feedback data 545. These begin with optionally transcoding the audio and video signals. Then, by varying frame rate, pixel and color resolutions in response to a frame set backdrop, determined based upon minimum number of frames per second and minimum pixel and color resolutions required, for a set of frames, for not having a discernable difference in picture quality. Then, the re-encoding processes continue by compressing the digital video signal in an optimal and adaptive manner. Then, time shifting and tone adaptation processes are performed by applying synchronization and compensative sound effects on the digital audio signals to compensate for the adaptive reductions in frame rate. Then these signals are packetized and time stamped and re-transmitted 551 via Internet 511, 513 to recipient devices via intermediate nodes, such as 561.

Similarly, at the intermediate nodes also the channel optimization modules 561 perform optimal delivery functionalities, when they receive these IP video program packets. These processes at the intermediate nodes begin at 565. The channel optimization modules 561 at regular intervals send 563 and receive 567 channel condition information and recipient device configuration information from other intermediate nodes and recipient end 543 feedback controllers 595 via other nodes 511, 513.

Optionally, the channel optimization modules 561 at the intermediate nodes then decode 569 the incoming IP video program packets to generate digital audio and video signals. Then, the channel optimization modules 561 begin re-encoding processes 571 based upon the received feedback data 567. These begin with generating missing frames and then, optionally, transcoding the audio and video signals. The missing frame generation functionality involves identification of similarities in the magnitudes that fall within a threshold, in their respective pixel and color positions, between the preceding and succeeding sequential video frames, followed by computation of average values or incremental magnitudes, for each of the missing sequential video frames, in their respective pixel and color positions, when the magnitudes fall beyond the threshold, from the preceding and succeeding sequential video frames. Then, missing frames are restored by combining the similar pixels and colors and difference pixels and colors, in their respective missing video frames, and pixel and color positions.

Then, the processes continue by varying frame rate, pixel and color resolutions in response to a frame set backdrop, determined based upon minimum number of frames per second and minimum pixel and color resolutions required, for a set of frames, for not having a discemable difference in picture quality. Then, the video frames are compressed in an optimal and adaptive manner. Then, time shifting and tone adaptation processes are performed by applying synchronization and compensative sound effects on the digital audio signals to compensate for the adaptive reductions in frame rate. Then these signals are packetized and time stamped and sent 573 via Internet 513 to recipient devices 543 via other intermediate nodes.

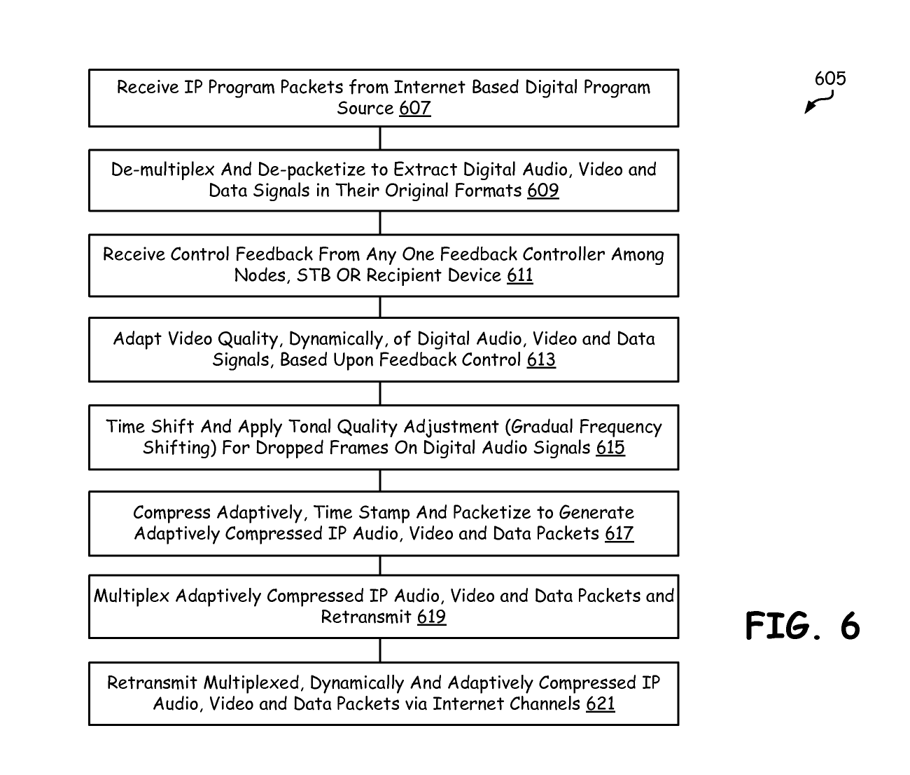

FIG. 6 is a flow diagram illustrating functionality of a channel optimization module according to one or more embodiments of the present invention. The operations 605 begin at a block 607, when the channel optimization modules receive IP program packets from a digital program source. The digital program source may be any of the Internet Service Provider's (ISP's) equipments or may process and re-route programs originated by other program sources.

At a next block 609, the channel optimization modules de-multiplex and de-packetize incoming IP program packets to separate audio, video and data packets and to remove internet protocol information, and thus extract compressed digital audio, video and data contents. Then, the channel optimization modules decompress the compressed digital audio, video and data contents to extract digital audio, video and data program signals. At a next block 611, the channel optimization modules receive feedback control data from any one of feedback controller among nodes, STB, or recipient device. This may include channel condition information and recipient device configuration.

At a next block 613, the channel optimization modules adapt video quality, dynamically, to reduce bandwidth requirements of the Internet as well as to reduce processing and buffering requirements at the recipient device. The video quality adaptation involves varying frame rate, pixel and color resolutions, based upon minimum number of frames per second and minimum pixel and color resolutions required, for a set of frames, for not having a discernable difference in picture quality) and feedback control data.

At a next block 615, the channel optimization modules time shift and apply tone adaptation on digital audio program signals. This is done by initially eliminating digital audio program signals that correspond to the dropped frames during the adaptive reductions in frame rate, reassembling the rest of the digital audio program signals and re-synchronizing the remaining digital audio program signals with that of digital video program signals. Once the time shifting operation is completed, the channel optimization modules gradually shift frequency upwards and then downwards in such a way as to not have any discernable unwanted effects in audio reproductions.

Then, at a next block 617, the channel optimization modules adaptively compress the digital audio, video and data signals in their original formats to generate adaptively compressed digital audio, video and data signals. Then, the channel optimization modules insert time stamps and packetize the resulting signals. Then, at a next block 619, the channel optimization modules multiplex adaptively compressed IP audio, video and data packets. At a final block 621, the channel optimization modules retransmit these IP program packets to the recipient device via Internet.

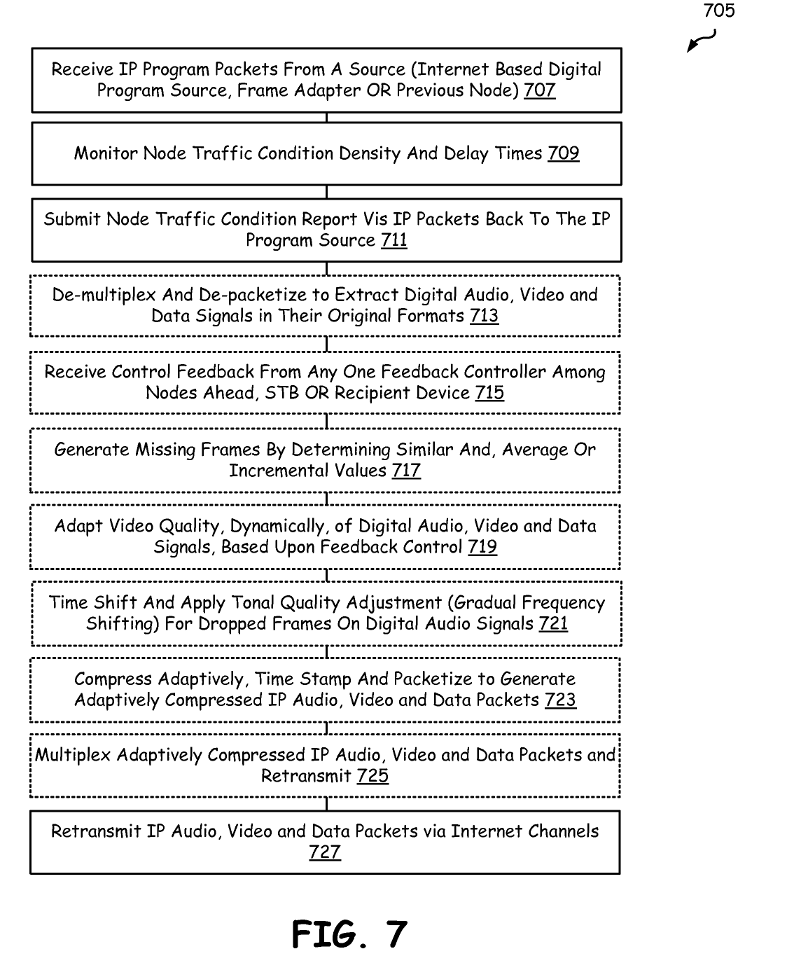

FIG. 7 is a flow diagram illustrating functionality 705 of a channel optimization module at of a communication pathway node according to one or more embodiments of the present invention. The functionality begins at 707, when the channel optimization modules at the intermediate nodes receive IP program packets from a digital program source, frame adapter, or previous nodes. Then, the channel optimizing nodes monitor the channel condition such as traffic density and delay times at the node, at a next block 709. Then, at a next block 711, the channel optimization modules send these traffic condition reports to the preceding nodes as well as the source end.

At a next block 713, optionally, optimizing functionalities at the intermediate nodes begin with the channel optimization modules de-multiplexing and de-packetizing incoming IP program packets to separate audio, video and data packets and to remove internet protocol information, and thus extract compressed digital audio, video and data contents. Then, the channel optimization modules decompress the compressed digital audio, video and data contents to extract digital audio, video and data program signals. At a next block 715, the channel optimization modules receive feedback control data from any one of feedback controller among other nodes, STB, or recipient device. This may include channel condition information and recipient device configuration.

Then, at a next block 717, the channel optimizing modules generate or restore missing frames. The missing frame generation functionality involves identification of similarities in the magnitudes that fall within a threshold, in their respective pixel and color positions, between the preceding and succeeding sequential video frames. This is followed by computation of average values or incremental magnitudes, for each of the missing sequential video frames, in their respective pixel and color positions, when the magnitudes fall beyond the threshold, from the preceding and succeeding sequential video frames. Then, missing frames are restored by combining the similar pixels and colors and difference pixels and colors, in their respective missing video frames, and pixel and color positions.

At a next block 719, the channel optimization modules adapt video quality, dynamically, to reduce bandwidth requirements of the Internet as well as to reduce processing and buffering requirements at the recipient device. The video quality adaptation involves varying frame rate, pixel and color resolutions, based upon minimum number of frames per second and minimum pixel and color resolutions required, for a set of frames, for not having a discemable difference in picture quality) and feedback control data.

At a next block 721, the channel optimization modules time shift and apply tone adaptation on digital audio program signals. This is done by initially eliminating digital audio program signals that correspond to the dropped frames during the adaptive reductions in frame rate, reassembling the rest of the digital audio program signals and re-synchronizing the remaining digital audio program signals with that of digital video program signals. Once the time shifting operation is completed, the channel optimization modules gradually shift frequency upwards and then downwards in such a way as to not have any discernable unwanted effects in audio reproductions.

Then, at a next block 723, the channel optimization modules adaptively compress the digital audio, video and data signals in their original formats to generate adaptively compressed digital audio, video and data signals. Then, the channel optimization modules insert time stamps and packetize the resulting signals. Then, at a next block 725, the channel optimization modules multiplex adaptively compressed IP audio, video and data packets. At a final block 727, the channel optimization modules retransmit these IP program packets to the recipient device via Internet.

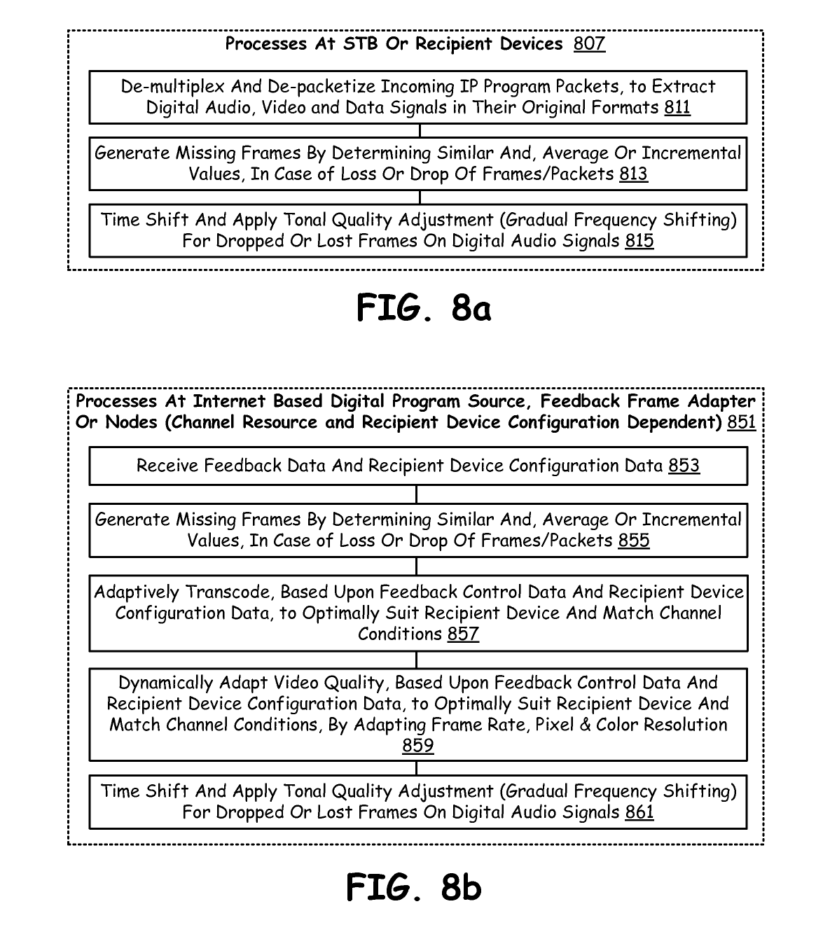

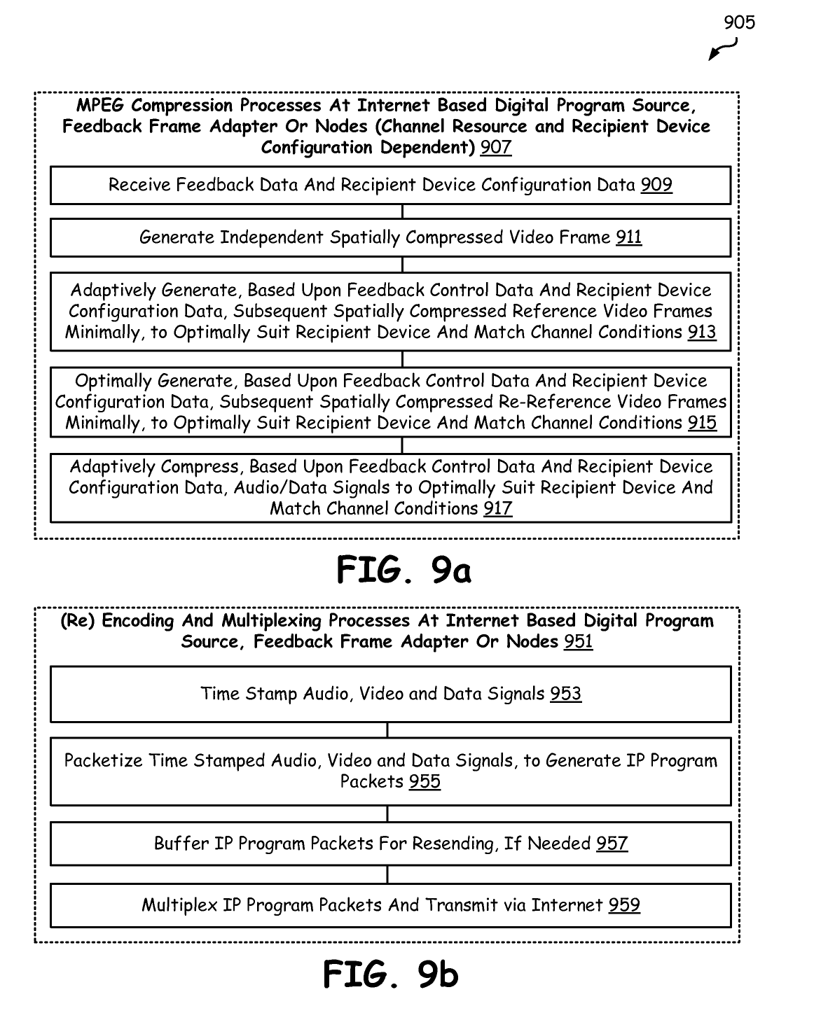

FIG. 8a is a flow diagram illustrating functionality of channel optimization modules at a recipient end device that may include missing frame generation and time shifting and tone adaptation according to one or more embodiments of the present invention. The functionalities 807 illustrated in FIG. 8a may include those of the channel optimization modules at the recipient end device, which may include missing frame generation, and time shifting and tone adaptation. The functionalities of FIGS. 8a, 8b, 9a, and 9b are various group combinations of the channel optimization module functionalities that may be incorporated selectively at source end, recipient end, or intermediate nodes.

The functionality begins at a block 811, when the channel optimization modules at the recipient end device de-multiplex and de-packetize incoming IP program packets to separate audio, video and data packets and to remove internet protocol information, and thus extract compressed digital audio, video and data contents. Then, the channel optimization modules decompress the compressed digital audio, video and data contents to extract digital audio, video and data program signals.

At a next block 813, the channel optimizing modules generate or restore missing frames. The missing frame generation functionality involves identification of similarities in the magnitudes that fall within a threshold, followed by computation of average values or incremental magnitudes when the magnitudes fall beyond the threshold, for each of the missing sequential video frames, in their respective pixel and color positions, from the preceding and succeeding sequential video frames. Then, missing frames are restored by combining the similar pixels and colors and difference pixels and colors, in their respective missing video frames, and pixel and color positions.

At a next block 815, the channel optimization modules time shift and apply tone adaptation on digital audio program signals. This is done by initially eliminating digital audio program signals that correspond to the dropped frames during the adaptive reductions in frame rate, reassembling the rest of the digital audio program signals and re-synchronizing the remaining digital audio program signals with that of digital video program signals. Once the time shifting operation is completed, the channel optimization modules gradually shift frequency upwards and then downwards in such a way as to not have any discernable unwanted effects in audio reproductions.

FIG. 8b is a flow diagram illustrating functionality of channel optimization modules at the source end or communication pathway nodes that may include one or more of feeding back channel condition information, video quality adaptation, missing frame generation, and time shifting and tone adaptation, transcoding, video quality adaptation, and time shifting and tone adaptation according to one or more embodiments of the present invention. The functionalities 851 of FIG. 8b may be those of the channel optimization modules at the source end or communication pathway nodes, which may include one or more of feeding back channel condition information, video quality adaptation, missing frame generation, and time shifting and tone adaptation, transcoding, video quality adaptation, and time shifting and tone adaptation. The functionality begins at a block 853, when the channel optimization modules at the source end or intermediate nodes receive feedback control data from any one of feedback controller among other nodes, STB, or recipient device. This may include channel condition information and recipient device configuration. At a next block 855, the channel optimizing modules restore missing frames (this may not be applicable at the source end). This is done by identifying similarities in the magnitudes followed by computation of average values or incremental magnitudes, between the preceding and succeeding sequential video frames, for each of the missing sequential video frames, in their respective pixel and color positions. Then, missing frames are restored by combining the similar pixels and colors and difference pixels and colors, in their respective missing video frames, and pixel and color positions.

The channel optimization modules at the source end or intermediate nodes, at a next block 857, adaptively transcode the digital audio and video signals, after missing frame generation, based upon the feedback control data. At a next block 859, the channel optimization modules at the source end or intermediate nodes adapt video quality, dynamically, to reduce bandwidth requirements of the Internet as well as to reduce processing and buffering requirements at the recipient device. This is done by varying frame rate, pixel and color resolutions, based upon minimum number of frames per second and minimum pixel and color resolutions required, for a set of frames, for not having a discernable difference in picture quality) and feedback control data.

At a final block 861, the channel optimization modules at the source end or intermediate nodes time shift and apply tone adaptation on digital audio program signals. This is done by initially eliminating digital audio program signals that correspond to the dropped or missing frames during the adaptive reductions in frame rate, reassembling the rest of the digital audio program signals and re-synchronizing the remaining digital audio program signals with that of digital video program signals. Once the time shifting operation is completed, the channel optimization modules gradually shift frequency upwards and then downwards in such a way as to not have any discernable unwanted effects in audio reproductions.

FIG. 9a is a flow diagram illustrating functionality of channel optimization modules at the source end or communication pathway nodes for adaptive and optimized compression according to one or more embodiments of the present invention. The functionalities 907 of FIG. 9a may be those of the channel optimization modules at the source end or communication pathway nodes, wherein an adaptive and optimized compression is performed. The functionality begins at a block 909, when the channel optimization modules at the source end or intermediate nodes receive feedback control data from any one of feedback controller among other nodes, STB, or recipient device. This may include channel condition information and recipient device configuration.

At a next block 911, the channel optimization modules at the source end or intermediate nodes generate an independent or base video frame which is already spatially compressed, from the video frames. At a next block 913, the channel optimization modules at the source end or intermediate nodes adaptively generate subsequent spatially compressed reference (predictive) video frames using minimal subsequent transcoded video frames. The optimum numbers of reference video frames to be generated, within a frame set, are determined by the recipient device's screen aspect ratio, its video processing and buffering capabilities, and also channel condition information.

At a next block 915, the channel optimization modules at the source end or intermediate nodes adaptively generate subsequent spatially compressed re-reference (bidirectional predictive) video frames using minimal subsequent transcoded video frames. Typically, for recipient devices with nominal processing and buffering capabilities, no re-referencing frames may be generated at all. In general, the numbers of re-reference video frames to be generated, within a frame set, are again determined by the recipient device's screen aspect ration, its video processing and buffering capabilities and channel condition information.

At a final block 917, the channel optimization modules at the source end or intermediate nodes generate adaptively compressed audio signals, based upon audio configurations of the recipient device (which may include bandwidth required for mono, stereo or surround sound reproduction capabilities) and channel conditions information.

FIG. 9b is a flow diagram illustrating functionality of re-encoding and multiplexing at the source end or communication pathway nodes according to one or more embodiments of the present invention. The functionality 951 of FIG. 9b may include re-encoding and multiplexing at the source end or communication pathway nodes. The functionality begins at a block 953, when the channel optimization modules at the source end or intermediate nodes begin re-encoding process by inserting time stamps separately to audio, video and data signals. Then, at a next block 955, the channel optimization modules at the source end or intermediate nodes packetize the resulting time stamped audio, video and data signals, by inserting IP (Internet Protocol) information that includes the recipient device internet address. At a next block 957, the channel optimization modules at the source end or intermediate nodes buffer some of the latest audio, video and data packets to resend any lost packets at a later time. Then, at a next block 959, the channel optimization modules at the source end or intermediate nodes multiplex IP program packets and retransmit via Internet.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip,” as used herein, refers to an integrated circuit. Circuits and circuitry may comprise general or specific purpose hardware, or may comprise such hardware and associated software such as firmware or object code.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. An Internet program infrastructure, comprising a source end, recipient end device and communication pathway comprising a plurality of nodes, that supports delivery of Internet protocol video program packets from the source end to recipient end device via the communication pathway, the Internet program infrastructure comprising:
video frame adapters that adapt video frames to optimize the recipient end device resources;
video quality adapters that adapt video frame rate, pixel and color resolutions to optimize channel and recipient end device resources;
time shifting and tone adaptation modules that synchronize and tone adapt audio signals to compensate for the video quality adaptation or lost video frames;
missing frame generation modules that restore missing frames that are lost during transmission;
the Internet program infrastructure, in a distributed manner, performs one or more functionalities of adapting video frames, adapting video quality, synchronizing and tone adaptation of audio signals, and generating any missing frames based upon channel conditions and the recipient device configurations to produce an optimal delivery system; and
the Internet program infrastructure produces the optimal delivery system, by utilizing the distributed components of the video frame adapters, video quality adapters, time shifting and tone adaptation modules and missing frame generation modules, respectively.

2. The Internet program infrastructure of claim 1, wherein the plurality of nodes and recipient end device further comprise feedback controller modules.

3. The Internet program infrastructure of claim 2, wherein the feedback controller modules are distributed in each of the plurality of nodes and recipient end device.

4. The Internet program infrastructure of claim 2, wherein the feedback controller modules provide feedback based upon channel condition information in each of the plurality of nodes and at the recipient end device.

5. The Internet program infrastructure of claim 4, wherein providing feedback includes providing channel condition information to a preceding node of the plurality of nodes and the source end.

6. The Internet program infrastructure of claim 5, wherein the channel condition information is provided by generating Internet protocol packets that contain the channel condition information.

7. The Internet program infrastructure of claim 6, wherein the channel condition information comprising traffic handling capability of a node.

8. The Internet program infrastructure of claim 6, wherein the channel condition information comprises traffic density of the node, at the time of receiving an Internet protocol video program packet from the source end.

9. The Internet program infrastructure of claim 6, wherein the channel condition information comprises delay in arrival of an Internet protocol video program packet at the node, from the preceding nodes and source end.

10. The Internet program infrastructure of claim 2, wherein the feedback controller module at the recipient end device provides feedback upon recipient device configuration information to a preceding node and the source end.

11. The Internet program infrastructure of claim 10, wherein the recipient device configuration information is provided by generating Internet protocol video program packets that contain the recipient end device configuration.

12. The Internet program infrastructure of claim 11, wherein the recipient device configuration information includes screen size and aspect ratio of the recipient end device.

13. The Internet program infrastructure of claim 11, wherein the recipient device configuration information includes mono, stereo, and surround sound capabilities of the recipient end device.

14. The Internet program infrastructure of claim 11, wherein the recipient device configuration information includes buffering and processing capabilities of the recipient end device.

15. A channel optimization module located at a node of a communication pathway, that communicates a plurality of Internet protocol video program packets from a source end to recipient end device, the plurality of channel optimization modules comprising:
a traffic monitoring module;
a traffic reporting module;
a video frame adapter;
a video quality adapter;
a time shifting and tone adaptation module;
a missing frame generation module;
the traffic monitoring module monitors channel conditions;
the traffic reporting module feeds back channel condition information to the source end and preceding nodes; and
the channel optimization module optimizes the delivery system, by one or more of:
the video frame adapter adapting video frames to the recipient end device configuration;
the video quality adapter adapting video quality to the channel conditions and recipient end device configuration;
the time shifting and tone adaptation module synchronizing audio signals and eliminating unwanted effects to compensate for lost or dropped frames; and
the missing frame generation module restoring any missing frames.

16. The channel optimization module of claim 15, wherein the channel condition information comprises traffic handling capability at the node.

17. The channel optimization module of claim 15, wherein the channel condition information comprises traffic density at the node.

18. The channel optimization module of claim 15, wherein the recipient end device configuration comprise screen size, aspect ratio, and mono, stereo, and surround sound capabilities of the recipient end device.

19. The channel optimization module of claim 15, wherein the recipient end device configuration comprises buffering, and processing capabilities of the recipient end device.

20. A method performed by one or more of a plurality of distributed channel optimization components of an Internet program infrastructure that delivers a plurality of Internet protocol video program packets from a source end to recipient end device, the method comprising:
monitoring channel conditions;
reporting channel condition information;
receiving recipient end device configurations;
decoding Internet protocol video program packets;
generating missing frames;
optimizing video frames to the recipient end device configurations;
adapting video quality to the channel condition and recipient end device;
synchronizing audio and eliminating unwanted effects in audio reproductions; and
re-encoding and sending the resultant the Internet protocol video program packets to the recipient end device.
